(19) United States
(12) Patent Application Publication
(10) Pub. No.: US 2015/0370803 A1
(43) Pub. Date: Dec. 24, 2015

(54) AUTOMATIC POSITIONING OF ELEMENTS IN A COMPUTER-BASED DOCUMENT

(71) Applicant: Kenshoo Ltd., Tel-Aviv (IL)

(72) Inventors: Moti Meir, Modi'in (IL); Michael Aronowich, Haifa (IL)

(21) Appl. No.: 14/836,928

(22) Filed: Aug. 26, 2015

Related U.S. Application Data
(63) Continuation of application No. 13/438,855, filed on Apr. 4, 2012, now abandoned.

(51) Int. Cl. G06F 17/30

(52) U.S. Cl. CPC G06F 17/3053; G06F 17/30554; G06F 17/30528; G06F 17/30864; G06F 17/30011

(57) ABSTRACT

Positioning an element in a computer-based document by determining, for each of a plurality of positions of a target element displayed in a plurality of computer-based documents, a first performance value associated with the target element, and a second performance value associated with a non-target element displayed in the plurality of computer-based documents, selecting one of the positions that meets predefined selection criteria as applied to the performance values, determining, for a position factor associated with the target element, a position factor value associated with the selected position, and assigning the position factor value to the position factor.

### CROSS-REFERENCE TO RELATED APPLICATION(S)

This application is a continuation of U.S. patent application Ser. No. 13/438,855 filed Apr. 4, 2012, entitled “Automatic Positioning Of Elements In A Computer-Based Document”, the contents of which is incorporated herein by reference.

### FIELD OF THE INVENTION

The present invention relates to computer-based document processing in general, and more particularly to automatic layout thereof.

### BACKGROUND OF THE INVENTION

Designers of computer-based documents, such as word processing documents or web pages, typically employ various considerations when deciding where to position elements within a document, such as text or multimedia content. Such considerations often include how different document layouts affect the behavior of individuals who read computer-based documents, such as how users utilize such documents. For example, one type of layout of the elements of a computer-based document may result in better memory retention for the reader than another type of layout of the same elements.

### SUMMARY OF THE INVENTION

In one aspect of the invention a method is provided for positioning an element in a computer-based document, the method including determining, for each of a plurality of positions of a target element displayed in a plurality of computer-based documents, a) a first performance value associated with the target element, and b) a second performance value associated with a non-target element displayed in the plurality of computer-based documents, selecting one of the positions that meets predefined selection criteria as applied to the performance values, determining, for a position factor associated with the target element, a position factor value associated with the selected position, and assigning the position factor value to the position factor.

In another aspect of the invention the method further includes making the position factor value available to a document generator configured to use the position factor value when positioning the target element in a computer-based document.

In another aspect of the invention the method further includes determining a total of the performance values for each of the positions, where the selecting includes selecting one of the positions having a total performance value that meets predefined selection criteria.

In another aspect of the invention the method further includes selecting the target element and the non-target element wherein at least one of the elements affects the performance value of other of the elements.

In another aspect of the invention a system is provided for positioning an element in a computer-based document, the system including a performance evaluator configured to determine, for each of a plurality of positions of a target element displayed in a plurality of computer-based documents, a) a first performance value associated with the target element, and b) a second performance value associated with a non-target element displayed in the plurality of computer-based documents, and a position selector configured to select one of the positions that meets predefined selection criteria as applied to the performance values, determine, for a position factor associated with the target element, a position factor value associated with the selected position, and assign the position factor value to the position factor.

In another aspect of the invention the position selector is configured to make the position factor value available to a document generator configured to use the position factor value when positioning the target element in a computer-based document.

In another aspect of the invention the performance evaluator is configured to determine a total of the performance values for each of the positions, and the position selector is configured to select one of the positions having a total performance value that meets predefined selection criteria.

In another aspect of the invention at least one of the elements affects the performance value of other of the elements.

In another aspect of the invention a computer program product is provided for positioning an element in a computer-based document, the computer program product including a computer-readable storage medium, and computer-readable program code embodied in the computer-readable storage medium, where the computer-readable program code is configured to determine, for each of a plurality of positions of a target element displayed in a plurality of computer-based documents, a) a first performance value associated with the target element, and b) a second performance value associated with a non-target element displayed in the plurality of computer-based documents, select one of the positions that meets predefined selection criteria as applied to the performance values, determine, for a position factor associated with the target element, a position factor value associated with the selected position, and assign the position factor value to the position factor.

In another aspect of the invention the computer-readable program code is configured to make the position factor value available to a document generator configured to use the position factor value when positioning the target element in a computer-based document.

In another aspect of the invention the computer-readable program code is configured to determine a total of the performance values for each of the positions and select one of the positions having a total performance value that meets predefined selection criteria.

In another aspect of the invention the computer-readable program code is configured to operate wherein at least one of the elements affects the performance value of other of the elements.

In another aspect of the invention a method is provided for positioning an element in a computer-based document, the method including determining, for each of a plurality of positions of a target element displayed in a plurality of computer-based documents, a) a first performance value associated with the target element, and b) a second performance value associated with a non-target element displayed in the plurality of computer-based documents, identifying any of the positions where the second performance value falls within a target value range, selecting one of the identified positions that meets predefined selection criteria as applied to the first performance value, determining, for a position factor associated with the target element, a position factor value associated with the selected position, and assigning the position factor value to the position factor.

In another aspect of the invention the method further includes making the position factor value available to a document generator configured to use the position factor value when positioning the target element in a computer-based document.

In another aspect of the invention the determining includes determining where the first and second performance values are of dissimilar types.

In another aspect of the invention the determining, identifying, selecting, and assigning are performed where the computer-based document is a search engine result web page, where the target element is a paid advertisement for a product, where the non-target element is associated with the product, where the non-target element is not a paid advertisement, where the first performance value relates to revenue resulting from users who click on the paid advertisement and subsequently purchase the product, and where the second performance value relates to the number of users who click on the non-target element.

In another aspect of the invention the method further includes selecting the target element and the non-target element wherein at least one of the elements affects the performance value of other of the elements.

In another aspect of the invention a method is provided for positioning a paid advertisement in a search engine results web page, the method including determining, for each of a plurality of positions of a paid advertisement displayed in a plurality of search engine results web pages, a) revenue associated with the paid advertisement, and b) revenue associated with an organic search engine result displayed in the plurality of search engine results web pages, where the organic search engine result is associated with a subject of the paid advertisement, selecting one of the positions having the greatest total revenue, determining for the paid advertisement a bid value associated with the selected position, and assigning the bid value to a bid associated with the paid advertisement.

In another aspect of the invention the method further includes making the bid available to a search engine configured to use the bid when positioning the paid advertisement in a search engine results web page.

In another aspect of the invention the method further includes determining a total of the revenues for each of the positions, where the selecting includes selecting one of the positions having a total revenue that meets predefined selection criteria.

In another aspect of the invention a system is provided for positioning a paid advertisement in a search engine results web page, the system including a performance evaluator configured to determine, for each of a plurality of positions of a paid advertisement displayed in a plurality of search engine results web pages, a) revenue associated with the paid advertisement, and b) revenue associated with an organic search engine result displayed in the plurality of search engine results web pages, where the organic search engine result is associated with a subject of the paid advertisement, and a position selector configured to select one of the positions having the greatest total revenue, determine for the paid advertisement an average daily bid value associated with the selected position, and assign the average daily bid value to an average daily bid associated with the paid advertisement.

In another aspect of the invention the performance evaluator is configured to make the average daily bid available to a search engine configured to use the average daily bid when positioning the paid advertisement in a search engine results web page.

In another aspect of the invention the position selector is configured to determine a total of the revenues for each of the positions and select one of the positions having a total revenue that meets predefined selection criteria.

The term “product” as used herein may refer to any goods or services.

### BRIEF DESCRIPTION OF THE DRAWINGS

The invention will be understood and appreciated more fully from the following detailed description taken in conjunction with the appended drawings in which:

FIG. 1 is a simplified conceptual illustration of a system for automatic positioning of elements in a computer-based document, constructed and operative in accordance with an embodiment of the invention;

FIG. 2 is a simplified flowchart illustration of an exemplary method of operation of the system of FIG. 1, operative in accordance with an embodiment of the invention;

FIG. 3 is a simplified table of positions and related performance values illustrating aspects of the system of FIG. 1 and method of FIG. 2;

FIG. 4 is a simplified flowchart illustration of an exemplary method of operation of the system of FIG. 1, operative in accordance with an alternative embodiment of the invention; and

FIG. 5 is a simplified table of positions and related performance values illustrating aspects of the system of FIG. 1 and method of FIG. 4.

### DETAILED DESCRIPTION OF THE INVENTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

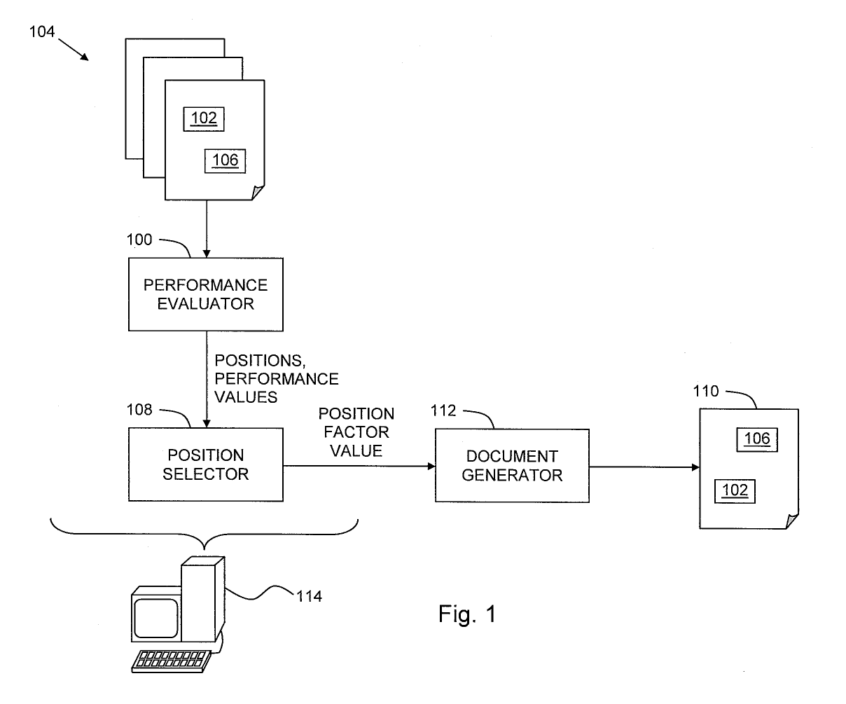

Reference is now made to FIG. 1, which is a simplified conceptual illustration of a system for automatic positioning of elements in a computer-based document, constructed and operative in accordance with an, embodiment of the invention. In the system of FIG. 1, a performance evaluator 100 determines, for each of a number of different positions in which a target element 102 is displayed in each of multiple computer-based documents 104 in which both target element 102 and a non-target element 106 are displayed, a performance value associated with target element 102, and a performance value associated with non-target element 106. Performance evaluator 100 may determine the performance values by measuring the performance values or by otherwise acquiring the performance values from a source external to performance evaluator 100. Performance evaluator 100 preferably determines the total of the performance values for each of the different positions, preferably, where the performance values are of a type that may be added to each other. A position selector 108 selects one of the positions of target element 102 that meets predefined selection criteria as applied to the performance values in any relationship thereof, such as by selecting the position having the greatest total performance value, the lowest total performance value, a particular performance value ratio, or any mathematical relationship between them. Position selector 108 determines, for a position factor associated with target element 102, a position factor value associated with the selected position. Position selector 108 then assigns the position factor value to the position factor. Position selector 208 then makes the position factor available to a document generator 112 which uses the position factor value when determining the position of target element 102 within a computer-based document 110, where document generator 112 preferably displays target element 102 at or near the selected position in a computer-based document 110. Non-target element 106 may be positioned anywhere within computer-based document 110 aside from the position of target element 102. Any of the elements shown in FIG. 1 are preferably implemented by one or more computers, such as by a computer 114, in computer hardware and/or in computer software embodied in a non-transient, computer-readable medium in accordance with conventional techniques.

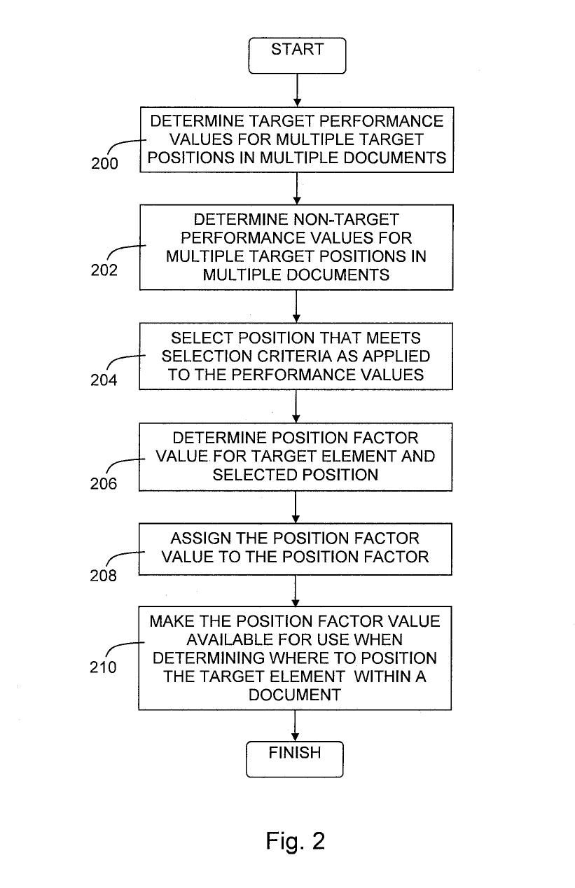

Reference is now made to FIG. 2, which is a simplified flowchart illustration of an exemplary method of operation of the system of FIG. 1, operative in accordance with an embodiment of the invention. In the method of FIG. 2, for each of a number of different positions of a target element displayed in multiple computer-based documents in which both the target element and a non-target element are displayed, a performance value associated with the target element is determined (step 200), and a performance value associated with the non-target element is determined (step 202). One of the positions of the target element is selected that meets predefined selection criteria as applied to the performance values (step 204), such as by selecting the position having the greatest total performance value. A position factor value is determined for a position factor associated with the target element, where the position factor value is associated with the selected position (step 206). The position factor value is assigned to the position factor (step 208). The position factor value is then made available for use when determining where to position the target element within a computer-based document (step 210) preferably where the target element is placed at or near the selected position in the computer-based document.

A specific target element and non-target element pair is preferably selected for use with the system of FIG. 1 and method of FIG. 2 where it is known, such as based on observation, that one affects the other and/or vice versa. For example, such a pair may be selected where it is known that the position of the target element affects the performance value of the non-target element, and/or vice versa.

The system of FIG. 1 and method of FIG. 2 may be illustrated by way of example, such as where target element 102 is a text description of a topic that is displayed in different positions in computer-based documents 104, which are word processing documents, while non-target element 106 may be an image of a landscape that is displayed in the same documents. In this example, the performance values associated with the different positions of target element 102 within computer-based documents 104 may, for example, be rates at which readers of computer-based documents 104 recall details of target element 102, whereas the performance value associated with non-target element 106 relative to the different positions of target element 102 within computer-based documents 104 may, for example, be rates at which readers of computer-based documents 104 recall details of non-target element 106. One of the positions of target element 102 is selected that meets predefined selection criteria as applied to the performance values, such as by selecting the position having the greatest total recall rate. A position factor value is determined for a position factor associated with target element 102, where the position factor value is associated with the selected position. For example, the position factor may be a horizontal coordinate. The position factor value is assigned to the position factor. The position factor value is then made available for use when determining where to position target element 102 within computer-based document 110, such as by being made available to document generator 112, where computer-based document 110 is a word processing document that is generated by document generator 112 subsequent to the selection of the position, and where computer-based document 110 also preferably includes non-target element 106. Preferably, target element 102 is placed at or near the selected position within computer-based document 110.

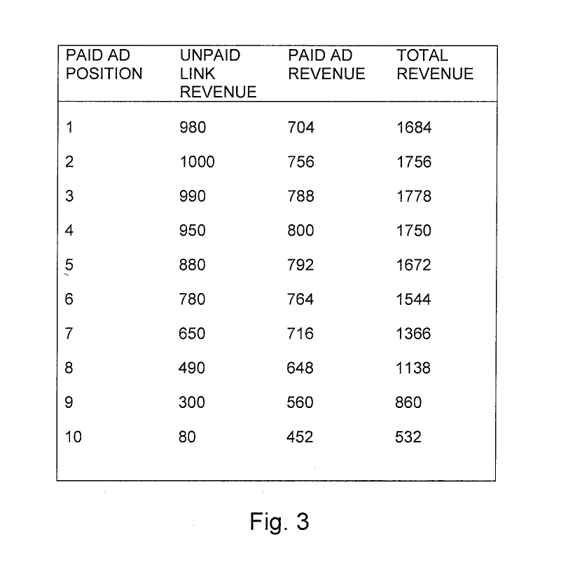

Alternatively, target element 102 may, for example, be a paid advertisement for a product that is displayed in different positions in computer-based documents 104, which are search engine result web pages produced by document generator 112, being a search engine, while non-target element 106 may be a link to the same product in the same search engine result web pages, where the link is not a paid advertisement but is, for example, an “organic” search engine result, where organic search results are typically elements on search engine results pages that appear because of their relevance to search terms and without being paid for. In this example, the performance values associated with the different positions of target element 102 within computer-based documents 104 may, for example, relate to revenue resulting from users who click on the paid advertisements and subsequently purchase the product, whereas the performance value associated with non-target element 106 relative to the different positions of target element 102 within computer-based documents 104 may, for example, relate to revenue resulting from users who click on the not-paid-for (i.e., organic) link and subsequently purchase the product, thereby generating revenue. Preferably, target element 102 and non-target element 106 are selected where it is known that their positions with respect to one another within computer-based documents 104 affect one or both of their performance values, such as by increasing or decreasing the revenue associated with one or both. One of the positions of target element 102 is selected that meets predefined selection criteria as applied to the performance values, such as by selecting the position having the greatest total revenue that was generated from users clicking on both paid advertisements and organic search results. Thus, for example, position 3 in the table shown in FIG. 3 may be selected as having the greatest total revenue. A position factor value is determined for a position factor associated with target element 102, where the position factor value is associated with the selected position. For example, the position factor may be an average daily bid that is associated with one or more keywords, where document generator 112, being a search engine, is configured in accordance with conventional techniques to a) display target element 102 in a search engine result web page in response to a search engine query that includes the keyword(s), and b) position target element 102 within the search engine result web page as a function of the average daily bid. For example, the Kenshoo Portfolio Optimizer™ (KPO), commercially-available from Kenshoo, Ltd., Tel-Aviv, Israel, may be employed to generate and manage bids in this manner. The position factor value is assigned to the position factor. The position factor value is then made available for use by document generator 112 when determining where to position target element 102 within computer-based document 110, being a search engine result web page, which also preferably includes non-target element 106. Preferably, target element 102 is placed at or near the selected position within computer-based document 110.

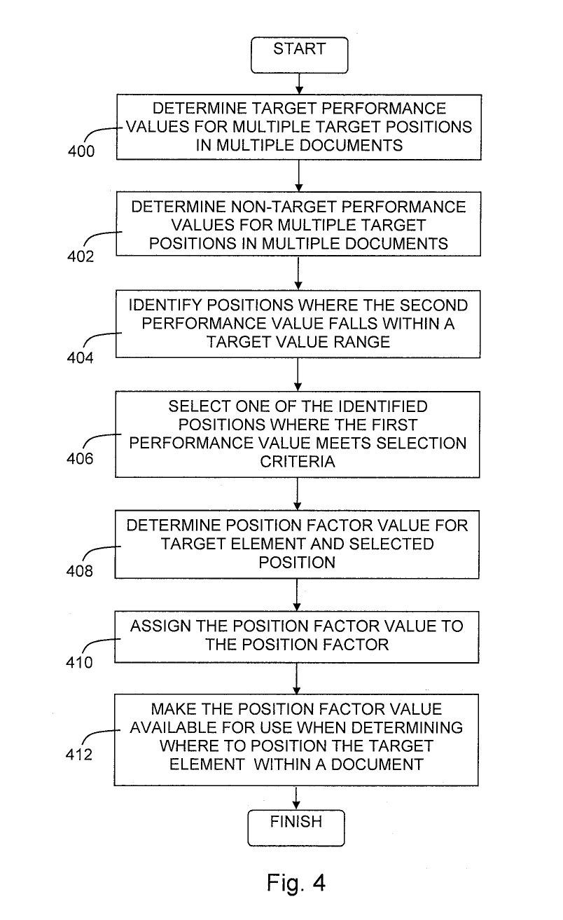

Reference is now made to FIG. 4, which is a simplified flowchart illustration of an exemplary method of operation of the system of FIG. 1, operative in accordance with an alternative embodiment of the invention. In the method of FIG. 4, for each of a number of different positions of a target element displayed in multiple computer-based documents in which both the target element and a non-target element are displayed, a performance value associated with the target element is determined (step 400), and a performance value associated with the non-target element is determined (step 402). One or more of the positions of the target element are identified where the second performance value falls within a target value range (step 404). One of the identified positions of the target element is selected that meets predefined selection criteria as applied to the first performance value (step 406). A position factor value is determined for a position factor associated with the target element, where the position factor value is associated with the selected position (step 408). The position factor value is assigned to the position factor (step 410). The position factor value is then made available for use when determining where to position the target element within a computer-based document (step 412), preferably where the target element is placed at or near the selected position in the computer-based document.

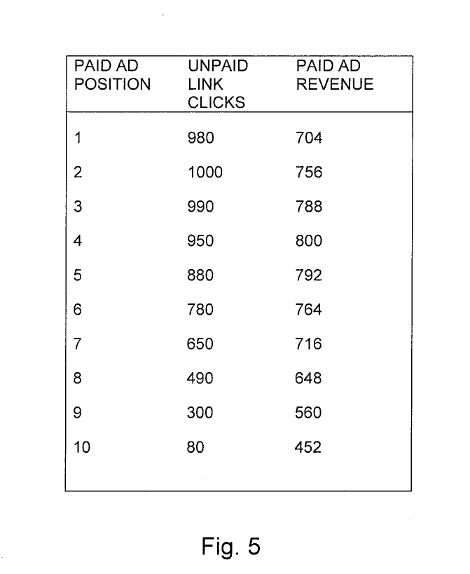

The system of FIG. 1 and method of FIG. 4 may be illustrated by way of example, such as where target element 102 is a paid advertisement for a product that is displayed in different positions in search engine result web pages as in the previous example, while non-target element 106 is an organic search engine result relating to the same product in the same search engine result web pages. In this variation of the previous example, the performance value associated with the different positions of target element 102 within computer-based documents 104 relates, as before, to revenue resulting from users who click on the paid advertisements and subsequently purchase the product. However, in contrast to the previous example, the performance value associated with non-target element 106 relative to the different positions of target element 102 within computer-based documents 104 relates to the number of user clicks on non-target element 106. Thus, the target and non-target performance values are of dissimilar types that are not typically added together. One or more of the positions of target element 102 are identified where the performance value associated with non-target element 106 falls within a target value range, such as 1000±100 user clicks. Thus, for example, positions 1-4 in the table shown in FIG. 5 are identified as falling within this range. One of the positions of target element 102 identified as falling within this range is selected that meets predefined selection criteria as applied to the performance value associated with the different positions of target element 102, such as by selecting the position among positions 1-4 having the greatest revenue, which in the table shown in FIG. 5 is position 4.

It is appreciated that the invention may be used to combine and benefit from metrics of different types and sources in order to position elements in computer-based documents. Although the system of FIG. 1 and methods of FIGS. 2 and 4 are described for the sake of brevity with respect to computer-based documents that include one non-target element, it is appreciated that they are also applicable for documents that include multiple non-target elements. For example, a web page may include an organic search engine query result linked to a product, an embedded video element (e.g., YouTube™), as well as a social indicator for the same product, such as indicators by members of a social network (e.g., Facebook™, Google+™) who “liked” or commented about the product.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A system comprising:
a non-transient computer readable storage medium having stored thereon instructions for:
(i) selecting a first element and a second element that are:
both displayed in each of multiple computer-based documents that are automatically generated by a document generator in response to multiple queries all containing at least one same keyword,
known to affect the performance of each other when displayed in each of said multiple computer-based documents,
(ii) collecting performance data associated with different positions where the first element is displayed in said multiple computer-based documents,
(iii) collecting performance data associated with the second element displayed in said multiple computer-based documents,
(iv) based on the performance data, determining which of the different positions of the first element maximizes a predefined performance criteria of the first and second elements combined,
(v) determining a numerical position factor that is estimated to cause the document generator to display the first element at the position that maximizes the predefined performance criteria of the first and second elements combined, and
(vi) making the numerical position factor available to the document generator, such that, when a new query which contains said at least one same keyword is provided to the document generator, the document generator generates a new computer-based document in which the first element is displayed at or near the position that maximizes the predefined performance criteria of the first and second elements combined; and
a processor configured to execute said instructions.

2. The system according to claim 1, wherein the different positions are different horizontal positions.

3. A method comprising:
selecting a first element and a second element that are:
(a) both displayed in each of multiple computer-based documents that are automatically generated by a document generator in response to multiple queries all containing at least one same keyword,
(b) known to affect the performance of each other when displayed in each of said multiple computer-based documents;
collecting performance data associated with different positions where the first element is displayed in said multiple computer-based documents;
collecting performance data associated with the second element displayed in said multiple computer-based documents;
based on the performance data, determining which of the different positions of the first element maximizes a predefined performance criteria of the first and second elements combined;
determining a numerical position factor that is estimated to cause the document generator to display the first element at the position that maximizes the predefined performance criteria of the first and second elements combined; and
making the numerical position factor available to the document generator, such that, when a new query which contains said at least one same keyword is provided to the document generator, the document generator generates a new computer-based document in which the first element is displayed at or near the position that maximizes the predefined performance criteria of the first and second elements combined.

4. The method according to claim 3, wherein the different positions are different horizontal positions.

5. A computer program product comprising a non-transient computer readable storage medium having stored thereon instructions executable by a processor for:
selecting a first element and a second element that are:
(a) both displayed in each of multiple computer-based documents that are automatically generated by a document generator in response to multiple queries all containing at least one same keyword,
(b) known to affect the performance of each other when displayed in each of said multiple computer-based documents;
collecting performance data associated with different positions where the first element is displayed in said multiple computer-based documents;
collecting performance data associated with the second element displayed in said multiple computer-based documents;
based on the performance data, determining which of the different positions of the first element maximizes a predefined performance criteria of the first and second elements combined;
determining a numerical position factor that is estimated to cause the document generator to display the first element at the position that maximizes the predefined performance criteria of the first and second elements combined; and
making the numerical position factor available to the document generator, such that, when a new query which contains said at least one same keyword is provided to the document generator, the document generator generates a new computer-based document in which the first element is displayed at or near the position that maximizes the predefined performance criteria of the first and second elements combined.

6. The computer program product according to claim 5, wherein the different positions are different horizontal positions.
